(19) United States
(12) Patent Application Publication
(10) Pub. No.: US 2026/0150863 A1
(43) Pub. Date: Jun. 4, 2026

(54) RESIDENTIAL FOOD WASTE RECYCLING

(71) Applicant: Norman BOYLE, Merimbula (AU)

(72) Inventor: Norman BOYLE, Merimbula (AU)

(21) Appl. No.: 18/710,503

(22) PCT Filed: Nov. 16, 2022
(86) PCT No.: PCT/AU2022/051371

§ 371 Date: May 15, 2024

(30) Foreign Application Priority Data
Nov. 16, 2021 (AU) 2021903671

(51) Int. Cl. A23K 10/37; A23K 10/26; A23K 30/20; A23K 40/10; A23N 17/00; B09B 101/70; B65F 1/02

(52) U.S. Cl. CPC A23K 10/37; A23K 10/26; A23K 30/20; A23K 40/10; A23N 17/004; A23N 17/007; B65F 1/02; B09B 2101/70; B65F 2210/128; B65F 2210/182; B65F 2210/184

(57) ABSTRACT

Disclosed herein is a method for converting residential food waste into a shelf stable biosecure product. The method comprises comminuting the food waste; dehydrating the comminuted food waste under conditions whereby a liquid by-product and a dehydrated granular product are formed; heating the granular product at a temperature and for a time effective to kill all pathogens; and storing the biosecure product.

### TECHNICAL FIELD

The present invention relates to methods and apparatus for converting residential food waste into a shelf stable biosecure product.

### BACKGROUND ART

Almost a third of food produced for human consumption is reportedly wasted, at enormous economic and environmental cost. Disposing of food waste at a commercial scale is becoming increasingly problematic, as it is generally no longer acceptable to send all food waste to landfill, and many ingenious solutions to this problem have been proposed. However, disposing of food waste at a residential or household scale in an environmentally appropriate manner has some unique challenges.

Apparatus for preventing residential food waste from ending up in landfill are known. For example, some sinks include a macerator inbuilt into their drain, where food waste is macerated as it drains from the sink, after which it can be flushed down the drain and into the sewer. Such waste disposal techniques can, however, cause significant problems in the sewage system.

Worm farms or compost bins may also be used to convert food waste into composting material, but these can suffer from capacity issues, require some space (and ideally a garden) and odour can be a problem. Some Councils in Australia offer a service where certain food wastes from households are collected periodically and used to generate biogas or produce compost or soil conditioner. However, this requires residents to store appropriate food waste (not all food waste can be used) for up to a week and can result in odour and infestation issues, particularly in the summer months.

Kitchen benchtop appliances which are operable to dry, grind and cool food scraps into granules for use as compost are also known. However, even though food waste processed using such appliances has been heated in order to dry it, there remains a significant risk that the dried product can still harbor a variety of microorganisms (particularly bacteria but also fungi) and viruses. If this processed food waste is used immediately as compost then this may not be a significant issue (although it can be), but the biosecurity risk significantly increases should the treated food waste be stored for any length of time.

It would be advantageous to provide alternative methods for processing residential food waste, particularly methods which might provide a more biosecure product.

### SUMMARY OF INVENTION

In a first aspect, the present invention provides a method for converting residential food waste into a shelf stable biosecure product. The method comprises comminuting the food waste; dehydrating the comminuted food waste under conditions whereby a liquid by-product and a dehydrated granular product are formed; heating the granular product at a temperature and for a time effective to kill all pathogens; and storing the biosecure product.

To the best of the inventor's knowledge, the incorporation of biosecurity protocols into food waste recycling on a domestic (i.e. by individual households, small restaurants, etc.) scale has not previously been contemplated. At the very least, therefore, the present invention provides a method in which residential food waste (e.g. kitchen food waste, out of date food, etc.) can be converted into a biosecure product, potentially for subsequent beneficial re-use. Once biosecure, the food waste product cannot be a source of bacterial, viral, fungal or any other pathogenic contamination, any of which could be undesirable in a household environment (e.g. because of odour issues) or cause significant health problems. As described above, food waste produced on a domestic scale has previously been difficult to manage in an economically viable manner, requiring regular collection (with the associated cost) and relying on households being compliant, notwithstanding a number of inconveniences. The biosecure product produced by the method of the present invention is shelf-stable and pathogen-free and can thus be stored for longer periods of time between collections without suffering from these issues.

The inventor believes that food waste can be used more beneficially (both from an economic and environmental viewpoint) than simply as compost. In this regard, the inventor notes that meat and dairy production systems have a significant impact on the environment, with a key driver of environmental impact in such systems being due to the feed consumed by the animals. Indeed, it is reported that feed accounts for about 35% of the carbon footprint of 1 kg of chicken meat and 76% of the carbon footprint of eggs.

The inventor recognised that food waste produced in accordance with the present invention may be used as an ingredient in animal feed production, as a replacement for other, higher value, ingredients (e.g. grain and protein) that would otherwise have been used. These principles are expected to also be applicable to other vendable products that can utilise such food waste instead of higher value ingredients.

The present invention therefore has the potential to mitigate two sources of significant environmental impact, namely the production of feed ingredients for animal rearing and the landfilling of food waste. Doing so would be expected to have a reduced environmental impact, reduce carbon emissions and contribute to a circular economy. Indeed, in a study commissioned by the inventor (described in further detail below), it was found that animal feed that includes food waste processed as described herein has lower greenhouse gas emissions and other environmental indicators than for conventional animal feed. The report notes that these benefits are almost exclusively due to the reduction of ingredients such as wheat and soy required for animal feed production.

In some embodiments, dehydrating the comminuted food waste may comprise agitating the food waste in a flow of hot air.

In some embodiments, the granular product may be heated to a temperature of about 100° C. for a period of at least 30 minutes. Heating to this temperature and for this time will ensure that any pathogens (e.g. microorganisms and viruses) that may be present in the product have been killed. Post-processing, the product is entirely biosecure.

In some embodiments, biosecure products collected from one or more conversions using the method of the first aspect may be stored for collection by a third party. For example, the biosecure products from successive batch conversions of food wastes can be emptied into a bin which is periodically collected, as described in further detail below.

In some embodiments, the method may further comprise measuring one or more of the following: the weight and volume of the food waste, the weight and volume of the biosecure product and the volume of the liquid by product. The data obtained from such measurements can be used for many purposes, including to determine one or more of: an amount of food waste not sent to landfill, a greenhouse gas emission saving and a tradeable unit for trading on a carbon market.

In a second aspect, the present invention provides an apparatus for converting residential food waste into a shelf stable biosecure product. The apparatus comprises a comminutor for comminuting food waste fed into the apparatus; a dehydrator for dehydrating the comminuted food waste whereby a liquid by-product and a dehydrated granular product are formed; and a heater for heating the granular product at a temperature and for a time effective to kill all pathogens.

In some embodiments, the apparatus may further comprise a hopper configured to receive and temporarily store food waste before comminution. In some embodiments, the apparatus may further comprise a bin for storing biosecure products collected from one or more conversions.

In some embodiments, the apparatus may further comprise detectors for measuring one or more of: the weight and volume of the food waste, the weight and volume of the biosecure product and the volume of the liquid by product.

In a third aspect, the present invention provides a system for recycling residential food waste. The system comprises a plurality of domestic users, each of whom convert their residential food waste into a shelf stable biosecure product, and a collector for collecting accumulated stored biosecure products from the plurality of domestic users and combining them to produce a product. The residential food waste is converted into a shelf stable biosecure product using a method that comprises: comminuting the food waste; dehydrating the comminuted food waste under conditions whereby a liquid by-product and a dehydrated granular product are formed; heating the granular product at a temperature and for a time effective to kill all pathogens; and storing the biosecure product (i.e. until collection).

Such a system can advantageously, and more economically than is the case for current systems, utilise the food waste produced by an entire community for beneficial reuse. Preferably the beneficial reuse also has a higher environmental impact than is the case for current systems, for example in the production of animal feeds, as described herein.

In a fourth aspect, the present invention provides a method for calculating a greenhouse gas emission saving obtained by performing the method of the first aspect of the present invention or the system of the third aspect of the present invention. The method comprises determining an amount of food waste not sent to landfill because it was converted into the biosecure product; determining an amount of a food product that is no longer required to produce a vendible product (e.g. a food product such as an animal feed or an animal feedstock) because the food product can be replaced by the biosecure product; and based on the results of these determinations, calculating a greenhouse gas emissions saving.

In a fifth aspect, the present invention provides a method for generating a tradeable unit for trading on a carbon market, the method comprising calculating the greenhouse gas saving in accordance with the fourth aspect of the present invention and determining an equivalent value of tradeable carbon units. It is envisaged that such might even further incentivise use of the present invention, and hence result in a greater proportion of residential food waste being recycled for use in a manner that has a higher environmental impact than composting.

Additional features and advantages of the various aspects of the present invention will be described below in the context of specific embodiments. It is to be appreciated, however, that such additional features may have a more general applicability in the present invention than that described in the context of these specific embodiments.

### BRIEF DESCRIPTION OF DRAWINGS

Embodiments of the present invention will be described in further detail below with reference to the following drawings, in which:

FIG. 1 shows a flowchart of a method in accordance with an embodiment of the present invention;

FIG. 2 shows a perspective view of an apparatus in accordance with an embodiment of the present invention;

FIG. 3 shows a perspective view of the apparatus of FIG. 2, with its lid in a raised position and its food hopper visible;

FIG. 4 shows a perspective view of the apparatus of FIG. 2, with its water tank removed;

FIG. 5 shows a perspective view of the apparatus of FIG. 2, with its heating chamber removed;

FIG. 6 shows a top view of the apparatus of FIG. 2; and

FIG. 7 shows a cross sectional view of the apparatus of FIG. 2, taken along the line A-A in FIG. 6.

### DESCRIPTION OF EMBODIMENTS

As noted above, the invention provides a method for converting residential (e.g. domestic kitchen or restaurant) food waste into a shelf stable biosecure product. The method comprises comminuting the food waste; dehydrating the comminuted food waste under conditions whereby a liquid by-product and a dehydrated granular product are formed; heating the granular product at a temperature and for a time effective to kill all pathogens; and storing the biosecure product for beneficial reuse, such as that described below.

The invention also provides an apparatus for converting residential food waste into a shelf stable biosecure product. The apparatus comprises a comminutor for comminuting food waste fed into the apparatus; a dehydrator for dehydrating the comminuted food waste whereby a liquid by-product and a dehydrated granular product are formed; and a heating chamber configured to heat the granular product at a temperature and for a time effective to kill all pathogens.

As described above, disposing of food waste in an environmentally sound manner has been an enduring challenge. The inventor of the invention the subject of the present application has previously devised methods for recycling food waste on a large scale for use in producing high quality animal feed. International (PCT) application no. PCT/AU2017/051130, the contents of which are incorporated herein in their entirety, describes these methods in detail. The inventor's efforts to date have related to large scale producers of food waste, the inventor having previously thought that food waste collection on a domestic scale would not be feasible due to the small volumes being produced and the challenging issues relating to storing food, even if dehydrated.

The invention disclosed herein has the potential to help solve the problems associated with food waste generated at a residential scale. The creation of an ecosystem of residential users who dispose of their food waste by producing shelf stable (and storage safe) biosecure products which may be collected periodically and then beneficially re-used has enormous environmental potential. For example, a Council known to the inventor in the Sydney region has about 97,000 residences, each of which are estimated to produce about 3.3 .kg/week food waste. Using the present invention, 3.3 .kg of food waste would result in about 1.5 kg of biosecure product (depending on the water content of the food waste, as discussed below) which can safely and conveniently be stored for many months between collections. Thus, even if only a third of residents were to use the invention, about 50 tonnes of biosecure product would be produced for collection every week, which could be used to produce an animal feed (e.g. poultry feed) in place of grains such as wheat. The potential environmental and economic savings are enormous, and without risk to the health and safety of the users.

Further, food waste currently needs to be collected on a weekly basis, at an absolute minimum, meaning that collection vehicles must attend households on a very frequent basis, which contributes detrimentally to the overall environmental impact of the system. In the present invention, however, it is envisaged that collection could be bi-monthly or even quarterly, given the relatively low volume of product produced and its biosecure nature (e.g. if 1.5 kg of biosecure product was produced by a household in a week, less than 20 kg would be produced in a quarter). The benefits to the environment of less frequent collections are immediately apparent. Having a less frequent collection regimen would also help to consolidate the assets required to do so and/or make larger collection areas logistically more feasible. It should also be noted that many Councils currently heavily subsidise the costs associated with the recycling of food waste, and significant cost savings would be made if food waste was instead collected by a third party.

The measurement and tracking functionalities described herein may help to even further incentivise domestic users to recycle their residential food waste (i.e. because their contribution to reducing greenhouse emissions can be quantified), with the possibility for rebates or even an income being yet further incentive.

Further, in the aftermath of the COVID-19 global pandemic, the inventor expects that there will be a greater focus on biosecurity issues. If not biosecure, stored food waste presents a risk of bacterial, viral or fungal contamination (with the attendant unpleasant odours etc.). Although these are far more pressing at an industrial level, they are no less important in domestic situations.

The primary use of the apparatus and method envisaged by the inventor is in a residential setting. It will be appreciated, however, that smaller restaurants which generate a smaller volume of waste than larger restaurants, may also be able to benefit from the present invention. As will be described below, it is envisaged that apparatus with different volumes of food processing capacity would be commercially available, such as might be required by a single or couple, a family and a small restaurant, for example.

Any residential food waste may be used in the present invention, including vegetable, cereal and meat scraps. Provided that they are comminutable, bones and other hard food waste such as oyster shells may also be added. In this manner, there is no need (or very little need) for a user to sort out their food waste, as is often required at present.

The shelf stable biosecure product may be used for any suitable purpose, and ideally for a purpose that results in a relatively high environmental impact, such as in the production of animal feed. As noted above, meat and dairy production, for example, have been increasingly scrutinised because of their relatively high impact on the environment. A key driver of environmental impact comes from the feed consumed by the animals, with feed reportedly accounting for about 35% of the carbon footprint of 1 kg of chicken meat delivered to market and 76% of the carbon footprint of eggs. The present invention thus has the potential to mitigate two sources of environmental impact: the production of feed ingredients for animal rearing and the landfilling of food waste.

Animal feeds which the inventor has produced and tested in real world applications include poultry feed, prawn feed and barramundi feed. Analysis of the nutritional content of food wastes produced in pubs, restaurants and hotels, which is expected to be comparable to that produced in a residential setting, show that such food wastes have levels of fat and protein compatible with an animal feed, particularly if blended with other sources of food waste as described in PCT/AU2017/051130. Similarly, the amino acid profile of food wastes expected to be comparable to that produced in a residential setting is likely to contribute beneficially to an animal feed. Indeed, the inventor expects that the biosecure product produced by many households could, for example, be used to feed domestic chickens, although maximum environmental benefit is more likely to be obtained if the product were to be incorporated into an industrial scale process.

A report was commissioned by the applicant to compare the potential life cycle environmental profile of animal feed produced as described in PCT/AU2017/051130 (incorporating food waste expected to be comparable to that produced in accordance with the present invention) in diets against conventional production of feed for poultry, prawn and barramundi, as well as the net environmental impact of the technology against conventional processes for food waste treatment: composting and anaerobic digestion. This report made the following key findings.
Compared with conventional commercial feed, the poultry and barramundi feeds are likely to have lower greenhouse gas emissions, eutrophication, fossil fuel scarcity, land use impacts and water use impacts. This is thanks to the lack of agricultural inputs such as wheat and soy, which drive those impacts for feed production.
In terms of how this impacts poultry production, the greenhouse gas emissions of 1 kg of chicken meat could decrease by at least 25%. For the production of eggs this would be circa 75%. For fish production, the reduction would be about 37%.
Seen as a pathway to treat food waste in alternative to landfill, the present invention has a lower environmental impact compared to anaerobic digestion and composting.

Biosecurity of food products is of paramount importance when these are sold to a consumer, but such is less regulated when it comes to food waste and particularly so at the household level. If food waste is to be used in the production of animal feed, however, then it is vital that it is biosecure, as many threats to animal welfare could present in unsafe feed. By way of example, such threats may include African swine fever, Aujeszky's disease and Brucella suis in pigs; arboviruses, avian adenovirus and avian influenza in poultry; as well as foot and mouth disease in livestock.

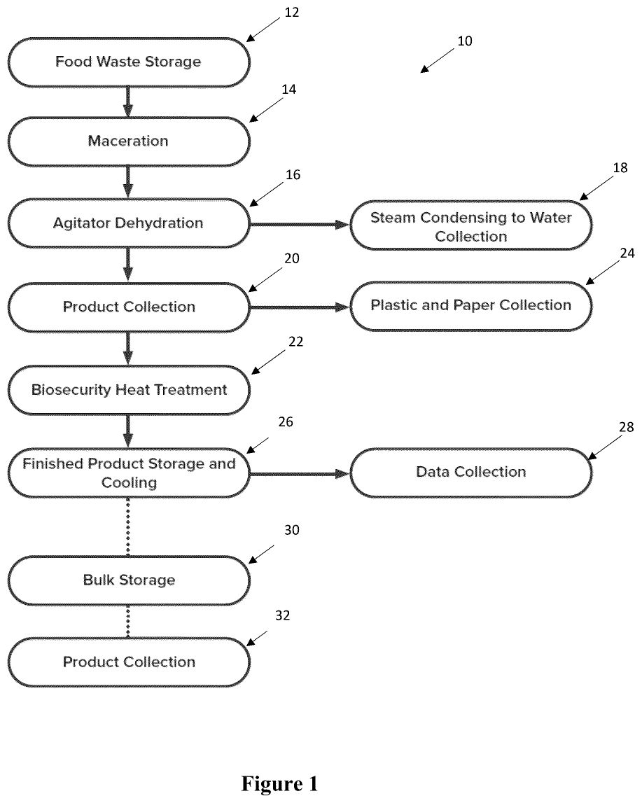

In light of the foregoing, the present invention provides a method for converting residential food waste into a shelf stable and biosecure product. A specific embodiment of the method will now be described, with reference to the flowchart shown in FIG. 1.

In method 10, food waste may be temporarily stored 12 whilst an appropriate volume is generated (e.g. over the course of a day, for smaller households). Whilst this food waste will start to spoil, it is envisaged that storage for a few hours will not be particularly detrimental. In a typical household, it is envisaged that food waste from breakfast lunch and dinner could be stored, with the method performed overnight and the biosecure product emptied the following morning.

The stored food waste is then comminuted 14. Comminution may be achieved using any suitable technique, such as by chopping, grinding and/or macerating (bearing in mind the wide variety of food scraps likely to be encountered), provided that the particle size of the comminuted food waste is able to be dehydrated sufficiently in the following step. Particles having sizes of less than about 5 mm (e.g. from about 1-5 mm, about 2-4 mm or about 3-5mm) are expected to be appropriate. As used herein, particle size means the longest distance between opposing sides of a piece of comminuted food waste. The term is to be understood as being somewhat general in nature, particles of comminuted food waste likely having a variety of shapes.

Once comminuted, the food is dehydrated 16 under conditions where a liquid by-product and a dehydrated granular product are formed. The liquid by-product, in the form of steam, can be condensed 18 for subsequent use, for example watering pot plants or the garden, or the like. The main product of the dehydration is a dehydrated granular product, which retains a significant proportion of the nutrients of the original food but very little water.

Any suitable technique may be used to dehydrate the comminuted food waste. In a particular embodiment (described below in further detail in relation to the apparatus), dehydrating the comminuted food waste comprises agitating the food waste in a flow of hot air. In use of the apparatus described below, for example, agitating the food waste in hot air having a temperature of about 350° C. has been found to be effective to dehydrate the comminuted food product in as little as 10 seconds.

The dehydrated granular product is then collected 20 for transfer to a heating chamber for the biosecurity heat treatment 22. At this stage, as the dehydrating apparatus described below heats the food waste up so quickly that it does not burn substances such as plastic or paper, any non-food waste (e.g. paper or plastic wrapping) may be separated 24 from the granular product at this stage. Such waste can be disposed of by conventional means.

In the biosecurity heat treatment 22, the granular dehydrated product is heated at a temperature and for a time effective to kill all pathogens (including all microorganisms such bacteria and fungi) and all viruses. Biosecurity heating protocols may be governed by regulation, based on scientific evidence or empirical determination, but all result to total pathogen inactivation. The inventor has found that heating dehydrated granular products for at least 30 minutes (e.g. 30-35 minutes) at a temperature of at least 100° C. (this being the temperature experienced by the products, not necessarily the chamber temperature) is effective to kill all of the microorganisms. Higher temperatures may be used but heating to such may start to adversely affect the nutrient content of the resultant biosecure product.

Once the biosecurity heat treatment has been conducted, the biosecure product is cooled for storage 26. Relevant measurements may be taken at this time 28, such as the weight of the biosecure product. Other measurements that may be taken include the weight and volume of the food waste (i.e. pre-maceration 14) and the weight and volume of the condensed liquid by-product 18. This data can be beneficial for the reasons described below.

The biosecure product produced by the batch operation described above can then be transferred to a bulk storage 30, where it is retained for collection 32 by a third party, for example. Collection may occur periodically (e.g. bi-monthly or quarterly) or may be ordered manually or automatically upon a certain weight of biosecure product being in bulk storage 30.

The measured data collected at 28 may be used to provide an indication (e.g. on a digital screen or a software application associated with the method or apparatus) of the volume of food waste that has been processed, as well as any useful information that can be derived from the data. For example, the measured data might be analysed to determine an amount of food waste not sent to landfill, a greenhouse gas emission saving and/or a tradeable unit for trading on a carbon market. Such information might provide a user with comfort in that they are doing something beneficial to the environment, or perhaps even a monetary return. Cumulative data may also be shown, so that a user can monitor the total greenhouse gas emission savings, for example (e.g. in total or over a calendar year).

The measured data may remain local to the method/apparatus or may be transmitted to a computing device for subsequent analysis. The apparatus may, for example, be internet-enabled and electronically communicate (e.g. wirelessly) with appropriate devices within the household. The computing device may, for example, be a user's mobile phone, where a software application is used to receive and analyse the data, and produce a useful output.

The data produced in the method may also be broadcast to a wider audience. For example, appropriately de-identified data could be sent to local, state or federal authorities for analysis and to monitor the benefits of the invention on a larger scale. As noted above, data may also be sent to the third party collector of the biosecure product, for their planning purposes (e.g. for collection or capacity planning).

As described above, recycling of food waste in the manner described herein has the potential to save greenhouse gas emissions and perhaps even generate a tradeable unit for trading on a carbon market. In another aspect therefore, the invention provides a method for calculating a greenhouse gas emission saving obtained by performing the present invention. The method comprises determining an amount of food waste not sent to landfill because it was converted into the biosecure product, determining an amount of a food product that is no longer required to produce a vendible product (e.g. an animal feed or an animal feedstock) because the food product can be replaced by the biosecure product and, based on the results of these determinations, calculating a greenhouse gas emissions saving.

The invention also provides a method for generating a tradeable unit for trading on a carbon market, the method comprising calculating the greenhouse gas saving in accordance with the preceding paragraph and determining an equivalent value of tradeable carbon units.

Users of the invention may, for example, join a “Carbon trading collective”, where the environmental benefits of using the invention are realised into a monetary (or otherwise) reward.

In another aspect, the invention also provides a system for recycling residential food waste. The system comprises a plurality of domestic users, each of whom convert kitchen food waste into a shelf stable biosecure powder, and a collector for collecting accumulated stored biosecure products from the plurality of users and combining them to produce a product. Residential food waste is converted into a shelf stable biosecure powder using a method that comprises: comminuting the food waste; dehydrating the comminuted food waste under conditions whereby a liquid by-product and a dehydrated granular product are formed; heating the granular product at a temperature and for a time effective to kill all pathogens; and storing the biosecure product (i.e. until collection).

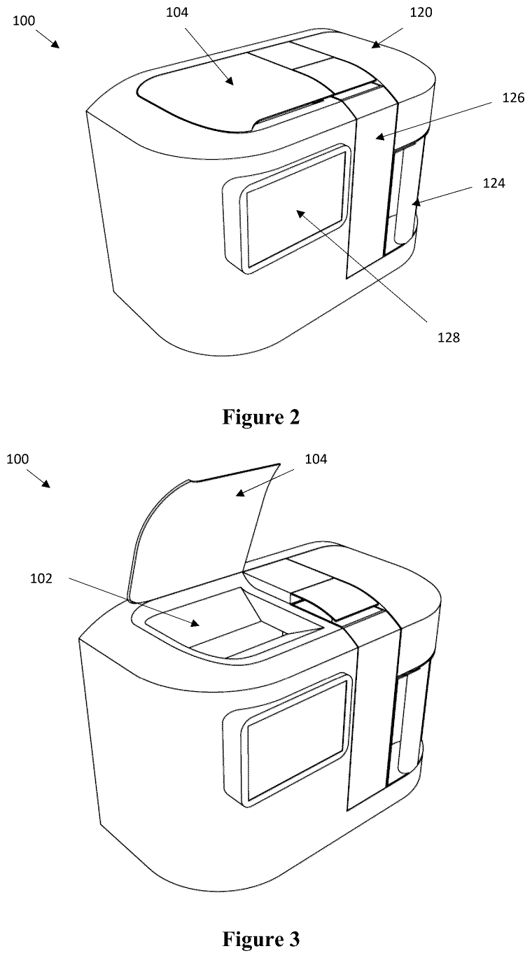

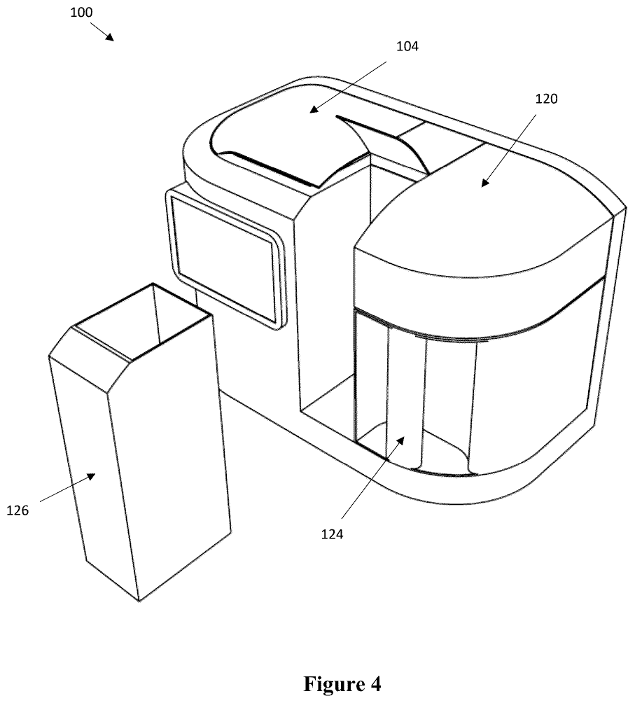

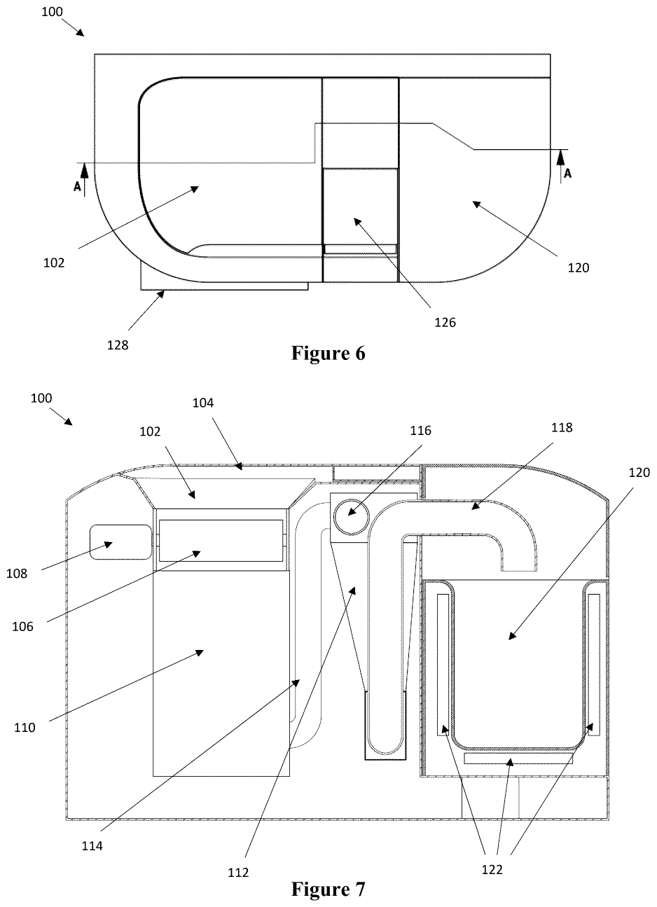

A specific embodiment of an apparatus for converting food waste into a shelf stable biosecure product in accordance with an embodiment of the present invention will now be described with reference to FIGS. 2 to 7.

The apparatus is shown in the form of unit 100, which incudes a food waste hopper 102 and hinging lid 104 to cover any food waste (not shown) placed in the hopper. Hopper 102 has a volume appropriate for temporarily storing food waste as it is generated, so that a full batch of food waste can be processed as described herein.

Unit 100 also includes a comminutor in the form of macerator 106. Motor 108 drives blades (not shown) in the macerator 106 such that any food waste in the hopper 102 passes through the macerator 106 whereupon it is macerated into smaller pieces of food waste. Macerated food waste falls into a dehydrator, shown in the form of agitator and dehydrator 110, which is operable to dehydrate the comminuted food waste by agitating it in the manner described below whilst exposing it to hot air (up to 350 C). Dehydrator 110 and cyclone separator 112 are adapted from the apparatus for drying and comminuting matter described in international (PCT) application no. PCT/AU89/00475, the contents of which are incorporated herein. Briefly, heated air is blown into and flows through the agitator 110, which strips moisture out of the comminuted food waste by turning it into a superheated steam. Agitator 110 also includes a number of rotating arms (not shown) which spin around an axis and act to maintain the comminuted food particles in the hot gas stream, as well as further reducing their size. The combination of hot air and agitation can result in relatively smaller particles of food waste drying very quickly, in as little as 10 seconds for some food wastes.

Once the particles are dehydrated and further comminuted to below a certain particle size, they become entrained in the airflow and exit the agitator 110 and enter the cyclone separator 112 via conduit 114. The cyclonic winds in cyclone separator 112 cause the heavier dehydrated comminuted food particles, to fall to the bottom of the separator in the form of a dehydrated granular product.

The dehydrator 110 thus produces a liquid by-product in the form of a superheated steam, which travels through conduit 114 and into water condenser 116, where it is condensed into a water storage vessel 126. When vessel 126 is full, an alarm is sounded, prompting the user to empty it, either down the sink or, more beneficially, by watering plants, etc. The unit 100 may even be prevented from operating if the vessel 126 contains a volume of water above a set threshold, in order for a complete processing cycle to be able to occur without risk of overflow or the need to stop mid-cycle to empty the vessel.

The dehydrator 110 also thus produces a second product stream in the form of a dehydrated granular product, which is essentially the non-liquid component of the original food waste. The relative proportions of solid and liquid products will obviously vary depending on the food product, with foods such as vegetables likely to produce around 20% solids and food waste such as cereals likely to produce around 80% solids.

The granular product is conveyed via conduit 118 into a heater in the form of heating chamber 120, where it can be heated to a temperature and for a time effective to kill all pathogens in the product. A number of heating elements 122 surround chamber 120 and provide a quick and even heating. Although not shown, a stirrer might also be present in order to agitate the product so that it is evenly heated. In this manner, the resultant product can be guaranteed to be completely free of any pathogens, including microorganisms such as bacteria and fungi and viruses.

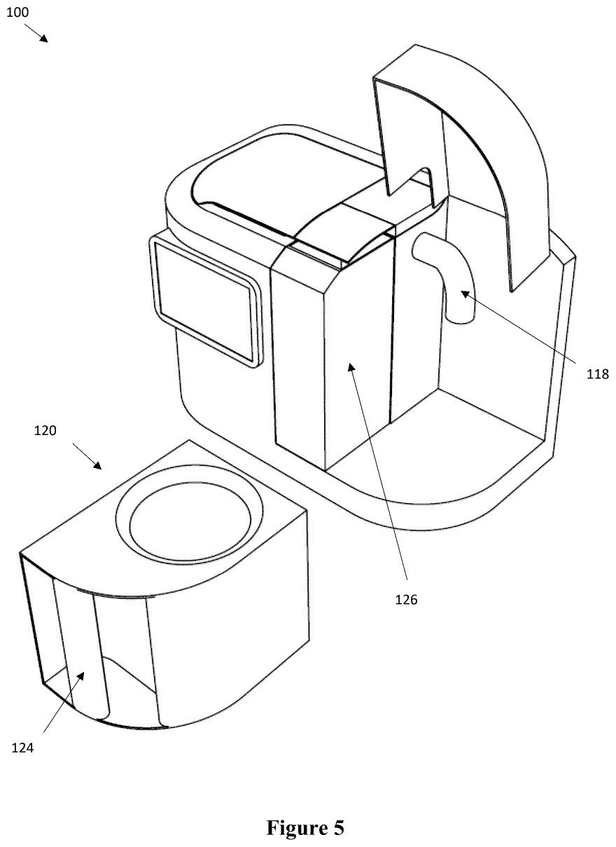

Chamber 120 is removeable from the unit 100, as described below, and would include a locking mechanism (not shown) in order to ensure that this could not occur whilst it was hot. Once the heat treatment is complete, the chamber 120 may be separated from the unit 100, as shown in FIG. 5, by a user grasping handle 124 and pulling outwardly. The biosecure product contained within chamber 120 can then be emptied into a bin (not shown), for storing until it is collected.

Although not shown, the unit 100 also includes detectors for measuring the weight and volume of the food waste (associated with hopper 102), the weight and volume of the biosecure product (associated with chamber 120) and/or the volume of the liquid by product (associated with vessel 126).

The unit 100 also includes a data transfer means in the form of a Bluetooth® or WiFi® communication transponder, which can transmit the measured data to a remote computing device for the purposes described above. Unit 100 may also include a digital screen 128, which displays information such as that described above or more mundane information such as the stage of the food waste processing cycle, time remaining and the level of water in the vessel 126.

It will be appreciated that the present invention provides a number of new and useful advantages. For example, specific embodiments of the present invention may provide one or more of the following advantages:
a compact unit that can be operated on a batchwise basis to process domestic food waste for beneficial reuse and in a biosafe manner;
the biosafe product can be used in domestic settings (e.g. for chicken food), but can also be used in industry as an ingredient in other products such as animal feeds, thereby providing an even greater environmental benefit that would be the case if the food waste were composted;
even though the amount of food waste produced in a residential setting is low, the ecosystem of users described above makes the present invention economically and environmentally feasible; and
processing food waste in a domestic environment provides immediate feedback to the user of a measurable benefit to the environment, which it is hoped will promote a more sustainable lifestyle.

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that any prior art publication referred to herein does not constitute an admission that the publication forms part of the common general knowledge in the art.

1. A method for converting residential food waste into a shelf stable biosecure product, the method comprising:
comminuting the food waste;
dehydrating the comminuted food waste under conditions whereby a liquid by-product and a dehydrated granular product are formed;
heating the granular product at a temperature and for a time effective to kill all pathogens; and
storing the biosecure product.

2. The method of claim 1, wherein the comminuted food waste has a particle size of less than about 5 mm.

3. The method of claim 1, wherein dehydrating the comminuted food waste comprises agitating the food waste in a flow of hot air.

4. The method of claim 3, wherein the hot air has a temperature of about 350° C.

5. The method of claim 1, wherein the liquid by-product is formed by condensing steam produced during dehydration.

6. The method of claim 1, wherein the granular product is heated to a temperature of about 100° C. for a period of at least 30 minutes.

7. The method of claim 1, further comprising removing any non-food waste from the granular product before heating.

8. The method of claim 1, any wherein the biosecure products collected from one or more conversions are stored for collection by a third party.

9. The method of claim 1, further comprising measuring one or more of the following: the weight and volume of the food waste, the weight and volume of the biosecure product and the volume of the liquid by product.

10. The method of claim 9, wherein the measured data are transmitted to a computing device for subsequent analysis.

11. The method of claim 9, wherein the measured data are analysed to determine one or more of: an amount of food waste not sent to landfill, a greenhouse gas emission saving and a tradeable unit for trading on a carbon market.

12. An apparatus for converting residential food waste into a shelf stable biosecure product, the apparatus comprising:
a comminutor for comminuting food waste fed into the apparatus;
a dehydrator for dehydrating the comminuted food waste whereby a liquid by-product and a dehydrated granular product are formed;
a heater for heating the granular product at a temperature and for a time effective to kill all pathogens.

13. The apparatus of claim 12, further comprising a hopper configured to receive and temporarily store food waste before comminution.

14. The apparatus of claim 12, further comprising a vessel for storing the liquid product.

15. The apparatus of claim 12, further comprising a bin for storing biosecure products collected from one or more conversions.

16. The apparatus of claim 12, further comprising detectors for measuring one or more of: the weight and volume of the food waste, the

17. (canceled)

18. A system for recycling residential food waste, the system comprising:
a plurality of domestic users, each of whom convert the residential food waste into a shelf stable biosecure product using a method that comprises:
comminuting the food waste;
dehydrating the comminuted food waste under conditions whereby a liquid by-product and a dehydrated granular product are formed;
heating the granular product at a temperature and for a time effective to kill all pathogens; and
storing the biosecure product, and
a collector for collecting accumulated stored biosecure products from the plurality of domestic users and combining them to produce a product.

19. The system of claim 18, wherein the combined biosecure products are a feedstock for an animal feed.

20. A method for calculating a greenhouse gas emission saving obtained by performing the method of claim 1, the method comprising:
determining an amount of food waste not sent to landfill because it was converted into the biosecure product;
determining an amount of a food product that is no longer required to produce a vendible product because the food product can be replaced by the biosecure product; and
based on the results of these determinations, calculating a greenhouse gas emissions saving.

21. The method of claim 20, wherein the vendible product is an animal feed or an animal feedstock.

22. (canceled)
